(19) United States
(12) Patent Application Publication
(10) Pub. No.: US 2004/0059562 A1
(43) Pub. Date: Mar. 25, 2004

(54) Systems and methods for calibrating emulated device performance

(76) Inventors: Eric D. Bergman, Palo Alto, CA (US); Paul J. Rank, San Jose, CA (US); Kirill Kounik, Tel-Aviv (IL)

Correspondence Address: Finnegan, Henderson, Farabow,, Garrett & Dunner, L.L.P., 1300 I Street, N.W., Washington, DC, 20005-3315, US

(21) Appl. No.: 10/247,560

(22) Filed: Sep. 20, 2002

(51) Int. Cl. G06F 9/455

(52) U.S. Cl. 703/23

(57) ABSTRACT

Systems and methods consistent with embodiments of the present invention provide for calibrating emulated device performance to reflect target device performance. In an exemplary method for calibrating emulated device performance, the method comprises generating a measurement of at least one parameter associated with the performance of the target device and the emulated device, determining an adjustment value for the emulated device associated with each parameter, and integrating each adjustment value into the emulated device to reflect the performance of the target device.

### BACKGROUND OF THE INVENTION

I. Field of the Invention

The present invention generally relates to the field of emulation, including the use of emulation software to simulate and test operational parameters related to a target device. More particularly, the invention relates to systems and methods for calibrating emulated device performance to reflect target device performance.

II. Background Information

Software development and evaluation for target devices, such as personal digital assistants (PDA's), mobile phones and settop boxes, is commonly performed on an emulated device running on a platform other than the target device. The emulated device has the ability to imitate the target device on the platform, such as a workstation or special purpose computing device. Software developers use emulated devices to confirm that the code they have written will run effectively on the target device.

The simulation of the target device is not perfect, however, due to differences in performance capability between it and the platform running the emulated device. For example, the emulated device typically runs on a platform with significantly greater processor speed, graphics speed, and/or memory capacity than the target device. These differences become more apparent in cases where the target device is small-in-size and, as a result, has a small memory footprint, low speed processor and/or limited graphics capabilities. In these cases, emulation of the target device may not actually represent actual performance of the target device. For example, executing a Java™ code application on an emulated phone running on a workstation may lead developers to believe that they have optimized the code for the phone, only to be disappointed when the application is slower when executed on an actual phone.

Accordingly, there is a need for improved methods and systems for calibrating emulated device performance to reflect the performance of the target device.

### SUMMARY OF THE INVENTION

Systems and methods consistent with embodiments of the present invention provide for calibrating emulated device performance on a platform to reflect target device performance. In accordance with one embodiment of the invention, a system is provided for calibrating an emulated device. The system generates a measurement of at least one parameter associated with the performance of the target device and the emulated device. Next the system determines an adjustment value for the emulated device associated with each parameter. Then the system integrates each adjustment value into the emulated device to reflect the performance of the target device.

In accordance with another embodiment of the invention, a calibration system is provided. The system comprises a target device and an emulated device in communication with the target device. The system further comprises a means for generating a measurement for at least one performance parameter on the target device and the emulated device generating a target device measurement and an emulated device measurement. The system further comprises a means for obtaining an adjustment value of the target device measurement to the emulated device measurement. The system further comprises a means for altering a performance parameter operation of the emulated device to reflect the performance of the target device.

In accordance with one embodiment of the invention, a method is provided for calibrating an emulated device to reflect the performance of a target device. The method comprises identifying at least one performance parameter for the target device. The method further comprises determining a performance ratio for the parameter and integrating the performance ratio into the emulated device, and then executing an application program on the emulated device, with the performance ratio permitting the performance of the emulated device to reflect the performance of the target device.

In accordance with one embodiment of the invention, a computer-readable medium is provided that stores instructions which when executed perform steps in a method for calibrating emulator performance for calibrating an emulated device. The method comprises identifying at least one performance parameter for the target device. The method further comprises determining a performance ratio for the parameter and integrating the performance ratio into the emulated device. The method executes an application program on the emulated device, with the performance ratio permitting the performance of the emulated device to reflect the performance of the target device.

### BRIEF DESCRIPTION OF THE DRAWINGS

The accompanying drawings provide a further understanding of embodiments of the invention and, together with the detailed description, explain certain features and exemplary embodiments of the invention. In the drawings:

FIG. 1 illustrates an exemplary system for calibrating an emulated device to a target device, consistent with an embodiment of the invention;

FIG. 2 is a block diagram of an exemplary computing system, consistent with an embodiment of the invention;

FIG. 3 illustrates exemplary programs that may be stored in memory, consistent with an embodiment of the invention;

FIG. 4 is a block diagram of an exemplary illustration of calibration program, consistent with an embodiment of the invention; and

FIG. 5 is a flowchart of an exemplary method for calibrating an emulation device to reflect target device performance, consistent with an embodiment of the present invention.

### DETAILED DESCRIPTION

Consistent with embodiments of the invention, methods and systems are provided for calibrating emulated device performance to reflect target device performance for any emulator running on an arbitrary platform. In general, categories performance-sensitive such as performance, graphics performance, network performance, and/or storage performance, are identified for the target device. A calibration process may then be performed for the identified categories by, for example, running a calibration application on the target device. The same calibration application is run on the emulated device.

In one embodiment, the calibration program performs a number of iterations of processor-intensive, graphics-intensive, storage-intensive, and/or network-intensive operations on the target device and the emulated device. These operations measure how long it takes the target device and the emulated device to perform an operation in each category. The measurements for the target device and the measurements for the emulated device are compared and used to generate performance ratios. The performance ratios are then calibrated to the specific platform running the emulated device and provide the emulated device with the ability to run at the approximate speed of the target device.

Embodiments of the present invention may be implemented in connection with various types of target devices and emulation devices. By way of a non-limiting example, an exemplary implementation will be described with reference to a mobile phone as the target device and the emulated device being implemented with emulation software running on a workstation. In one embodiment, the emulated device is a display of the target device on the screen of the workstation, presenting a visual display to the developer of an application program running in real time. In another embodiment, the emulated device answers questions presented by the developer, such as the amount of time the program will take to run. As can be appreciated by those skilled in the art, embodiments of the invention can be implemented for other types of target devices, such as PDA's, mobile phones, next-generation phones, settop boxes, thin-client devices, small computing devices, and/or any computing devices with a small memory footprint, low speed processor, limited graphics capabilities or any combination thereof. The emulated device may be running on a workstation or on a system created specifically for the target device.

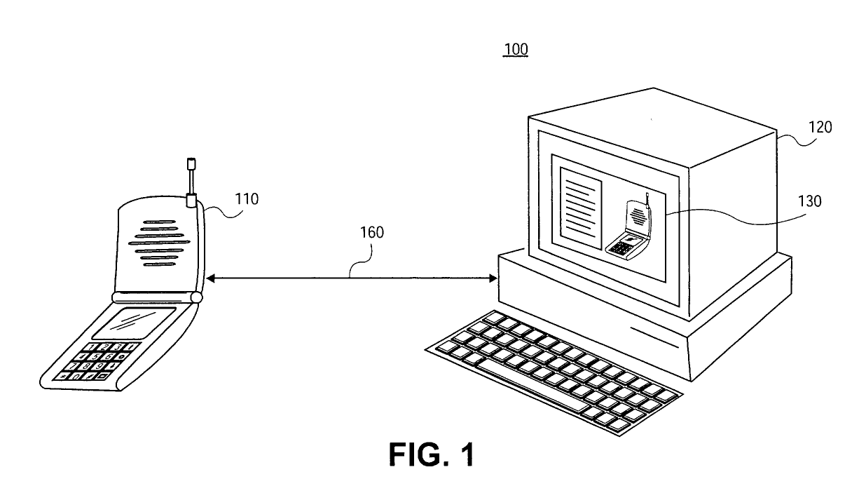

FIG. 1 depicts an exemplary system 100 for calibrating an emulated device to a target device, consistent with an embodiment of the invention. As shown in FIG. 1, system 100 includes a target device 110 and a workstation 120. Workstation 120 provides emulator 130, which may comprise emulation software that creates an emulated device to emulate target device 110. Both target device 110 and emulator 130 may execute a calibration program. Further, target device 110 and workstation 120 may communicate over a connection 160.

Target device 110 may be a mobile phone for which a developer may be developing an application program. Because of limitations such as its size, target device 110 may have a small memory footprint, low processor speed, and/or limited graphics capabilities. While target device 110 is illustrated in FIG. 1 as a mobile phone, other types of target devices may be used with system 100. As can be appreciated by those skilled in the art, target device 110 could also be a PDA, a settop box, a thin-client device, a small computing device and the like. Therefore, the embodiment of FIG. 1 should not be construed as being limited to implementations with mobile phones.

Workstation 120 is a platform capable of running an emulator and may be implemented using, for example, a personal computer, a laptop, a server or other computing platform. Application program development for target device 110 may take place on workstation 120. Thus, a developer may test an application program for a target device on workstation 120 before running the application program on target device 110. Although target device 110 and workstation 120 are different, emulator 130 is used to emulate running the application program on target device 110. Running the application program on the emulator enables the developer to work out bugs or errors in the application program before running the application program on target device 110.

Both target device 110 and emulator 120 are capable of running a calibration program. In one embodiment, the calibration program may be used to generate performance measures for target device 110 and emulator 130. In another embodiment, the target device 110 and emulator 130 have already generated performance measures. These values may be stored on a manufacturer's website for download by a developer. Emulator 130 may run the calibration program whenever changes are made to target device 110 or workstation 120. The values generated by the calibration program may be periodically updated.

In one embodiment, the calibration program is written in a platform independent language, such as Java™. In another embodiment, the calibration program is comprised of separate programs to account for platform dependencies. For example, the calibration program for target device 110 may be written in Java™, C++, C or any standard programming language and the calibration program for emulator 130 may be the same program run with a shell for interfacing with workstation 120. In one embodiment, the output of the calibration program includes a time measurement.

In one embodiment, connection 160 is provided between target device 110 and workstation 120. Connection 160 may be a physical connection for transmitting performance measure values and/or synchronizing the performance measure values with the emulator. Connection 160 may be implemented as a wired or wireless connection using conventional communication protocols and/or data port interfaces. By way of example, to implement connection 160, target device 110 and workstation 120 may be provided with conventional data ports, such as ADB, USB, SCSI, FIREWIRE, AAUI and/or BNC ports. In another embodiment, connection 160 may be a human-implemented connection, where a human is used to transfer performance measure values from target device 110 to workstation 120.

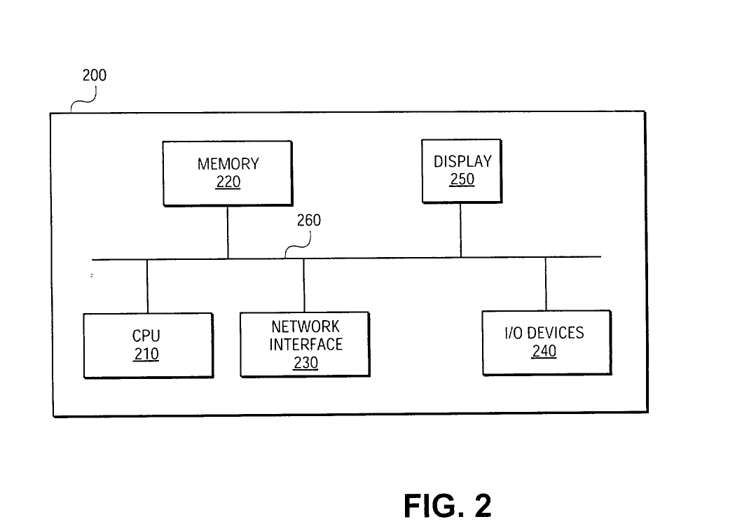

FIG. 2 is a block diagram of an exemplary computing system 200, consistent with an embodiment of the invention. Computing system 200 may represent, for example, the internal components of target device 110 or workstation 120 running emulator 130. By way of example, a program or set of instructions to run the calibration program on target device 110 or workstation 120 may be implemented in computing system 200.

Computing system 200 may include a number of components, such as a processor or central processing unit (CPU) 210, a memory 220, a network interface 230, I/O devices 240, and/or a display 250. Such components may be, interconnected by a system bus 260. CPU 210 may be a microprocessor such as the Pentium® family of microprocessors manufactured by Intel Corporation. However, any other suitable microprocessor, micro-, mini-, or mainframe computer may be used, such as a micro-controller unit (MCU), or a digital signal processor (DSP).

Memory 220 may include a random access memory (RAM), a readonly memory (ROM), a video memory, mass storage, and/or cache memory such as fixed and removable media (e.g., magnetic, optical, or magnetic optical storage systems or other available mass storage technology). Memory 220 stores support modules such as, for example, a basic input/output system (BIOS), an operating system (OS), a program library, a compiler, an interpreter, and/or a text-processing tool. Support modules are commercially available and can be installed on computing system 200 by those of skill in the art. For simplicity, these modules are not illustrated. Further, memory 220 may contain an operating system, an application routine, a program, such as a calibration program or application program, an application-programming interface (API), and/or other instructions for performing methods consistent with embodiments of the invention.

Network interface 230, examples of which include Ethernet, dial-up telephone and/or other conventional data port connections, may be used to communicate with other devices through, for example, connection 160 or a communication network (not shown). Computing system 200 may also receive input via by input/output (I/O) devices 240, which may include a keyboard, pointing device, or other like input devices. Computing system 200 may also present information and interfaces via by display 250 to a user.

Bus 260 may be a bi-directional system bus. For example, bus 260 may contain thirty-two address bit lines for addressing a memory 220 and thirty-two bit data lines across which data is are transferred among the components. Alternatively, multiplexed data/address lines may be used instead of separate data and address lines.

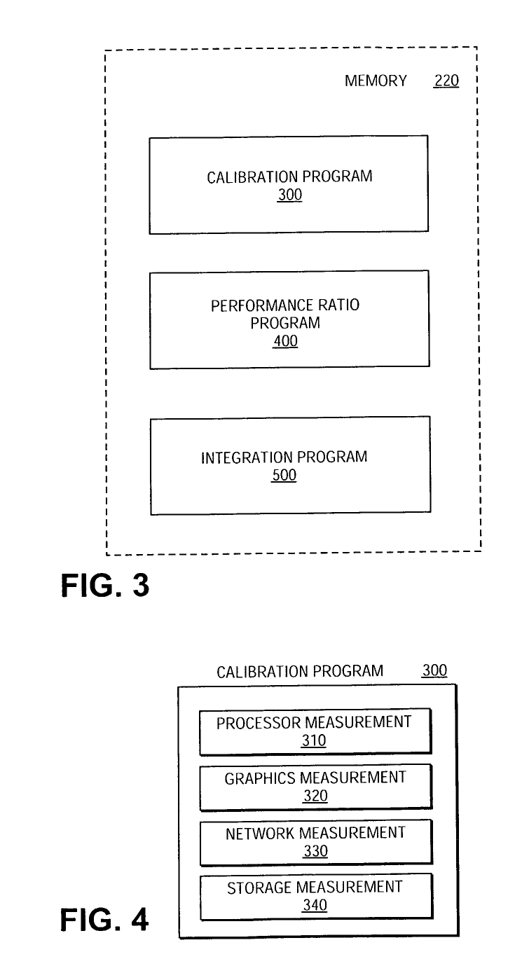

FIG. 3 is a block diagram of programs stored in memory, consistent with an embodiment of the invention. As illustrated in FIG. 3, a number of programs may be stored in memory, such as memory 220 of workstation 120 and/or target device 110. In one embodiment, all of the programs may be stored in and executed with either workstation 120 or target device 110. In another embodiment, the programs may be stored in a computer readable medium, such as a disk or memory stick, and executed when the computer readable medium and stored program instructions are read by workstation 120 or target device 110. In still another embodiment, one or more of the programs may be stored and executed remotely for generating, for example, performance measurements on emulator 130 or target device 110. In one embodiment, performance measurements or data related may be transferred from target device 110 to emulator 130 or workstation 120.

As illustrated in FIG. 3, the software-implemented programs may include a calibration program 300, a performance ratio program 400 and an integration program 500. Such programs may be implemented as separate executable programs, or the programs may be provided as components or routines of an integrated software application. The programs may be implemented with software or any combination of hardware, firmware and/or software to provide the necessary functionality and processes, consistent with embodiments of the invention.

FIG. 4 illustrates an exemplary implementation of calibration program 300, consistent with an embodiment of the present invention. Calibration program 300 may include one or more modules or routines for generating performance measurements on emulator 130 and/or target device 110. Examples of routines that may be provided as part of calibration program 300 include a processor-performance measurement routine 310, a graphics-performance measurement routine 320, a network-performance measurement routine 330, and/or a storage-performance measurement routine 340. In one embodiment, the measurement is the output of tests performed by a routine to reflect the average time required in order to perform one operation of a certain type.

In one embodiment, the calibration program is written in a platform independent language, such as Java™. In this example the same calibration program can be used across platforms. In another embodiment, the calibration program is comprised of separate programs to account for platform dependencies. In both embodiments, the output of the calibration program may include a time measurement.

Processor-performance measurements by routine 310 may be generated by a set of program instructions that does not perform network operations and few (or preferably no) graphics operations. In one embodiment, the number of byte-code operations in the program is set and the byte codes executed per second are measured.

Graphics-performance measurements by routine 320 may be generated by a set of program instructions containing the same “core” as the processor-performance measurement program, but also making extensive use of drawing graphics to a display or screen. By measuring how many pixels are drawn to the screen, the graphics rate may be determined. In another embodiment, graphics-performance measurements may be measured using graphics operations performed per second. By way of example, the graphics rate may be determined as follows:

g(pixels/sec)=(total pixels drawn)/(total time−time for processor tasks).

In another embodiment, graphics measurement routine 320 is implemented with a program where the processor time is considered to be “0” and graphic-performance measurement values are determined. In this embodiment, embodiment, all processing by the program can be considered to be part of the graphics operations, and the equation for graphics performance becomes, for example:

g(pixels/sec)=(total pixels drawn)/(total time).

Generating network-performance measurements with routine 330 may be achieved in a similar fashion to that for generating graphics-performance measurements with routine 320. For example, network-performance measurements may be generated with a program containing the same “core” as the processor-performance measurement program, but instead extensive use of network operations are made. For example, with a measure of how many bytes are being transferred (and this may be broken down further to bytes sent and bytes received), network performance may be determined as:

n(bytes transferred/sec)=(total bytes transferred)/(total time−time for processor tasks).

As with graphics measurement routine 320, in another embodiment, for routine 330 is a program where the processor time is assumed to be “0” and the program does only network operations. In this case, the equation for determining network performance values becomes:

n(bytes transferred/sec)=(total bytes transferred)/(total time).

Storage-performance measurements by routine 340 may be generated by a set of program instructions containing the same “core” as the processor measurement routine 310, but instead makes extensive use of storage operations. With a measure of how many bytes are being transferred from or to storage, the storage-performance measurement values may be determined as, for example:

n(bytes transferred/sec)=(total bytes transferred)/(total time−time for processor tasks).

Another embodiment is a program where the processor time is assumed to be “0” and the program only does storage operations. In this case, the above-noted equation simply becomes:

n(bytes transferred/sec)=(total bytes transferred)/(total time).

Calibration program 300 may execute a measurement program multiple times, such as hundreds or even thousand of iterations, to generate measurement values used to calculate performance measurements. Measurements from such iterations may be averaged or otherwise analyzed to provide a final set of measurement values in each category.

Performance ratio determination program 400 may contain routine(s) for generating performance ratios, given the performance measurements for target device 110 and emulator 130 generated by calibration program 300. The performance ratio may be a generated number indicating how different the emulator running on the particular platform varies from the target device. The performance measurement values provide a basis for comparing and resetting the performance values for the emulator.

In one embodiment, the performance measurement in the target device can be measured as follows:

| | |
|---|---|
| Pdevice | [byte codes executed per second on the device] |
| Gdevice | [pixels drawn per second by the device] |
| Ndevice | [network bytes transferred per second by the device] |
| Sdevice | [storage bytes transferred per second by the device] |

The performance measurement in the emulator can also be measured in a similar fashion using the following:

| | |
|---|---|
| Pemulator | [byte codes executed per second on the emulator] |
| Gemulator | [pixels drawn per second by the emulator] |
| Nemulator | [network bytes transferred per second by the emulator] |
| Semulator | [storage bytes transferred per second by the emulator] |

Consistent with an embodiment of the invention, one or more performance ratios may be generated by program 400, depending on the types of characteristics being used for calibration. By way of example, the above-noted measurements for the emulator and target device may be used to generate performance ratios as follows:

Pratio=Pdevice/Pemulator

Gratio=Gdevice/Gemulator

Nratio=Ndevice/Nemulator

Sratio=Sdevice/Semulator

The performance ratio for each category of performance may be used to adjust the emulator to reflect the target device performance.

Integration program 500 integrates the performance ratio into emulator 130 by, for example, introducing adjustment values or “wait” factors into the emulator. Each wait factor may be keyed to the identified category and define a set amount of time in a set time slice that the emulator needs to wait in order to best reflect the target device performance. Thus, if the emulator performs its processor tasks about 4 times faster than the target device, the emulator should be in a wait state for about 0.75 seconds for every second of processor time. The adjustment values can be calculated for each category, such as, for example:

P(wait)=processor wait=(1−Pratio)

G(wait)=graphics wait=(1−Gratio)

N(wait)=network wait=(1−Nratio)

S(wait)=storage wait=(1−Sratio)

In one embodiment, the wait factor may be applied to the specific performance category. The processor category task should execute P(wait) seconds worth of byte codes, then not execute any byte codes for the next 1−P(wait) seconds. The graphics task should draw to the screen for G(wait) seconds, and then wait for 1−G(wait) seconds. Thus, each wait factor should only affect the category it represents.

In one embodiment, the emulator may consist of a number of “perfect” threads. A perfect thread is a thread that only does one type of processing, e.g., a graphics thread that only does graphics drawing. To adjust the perfect threads so that the emulator performance matches that of the device, an adjustment value or “wait” time is introduced into the thread to put the thread “asleep” for the graphics wait value.

In another embodiment, the emulator consists of a number of mixed threads that combine different types of operations, such as processor operation and graphics operations. Before execution of a specific type of operation, the emulator will adjust its speed according to the adjustment value. This adjustment may not happen after every operation of specific type, such as a graphics operation. For example, the wait adjustment may happen once for every 100 graphics operations in order to avoid unnecessary overhead of the wait adjustment. The first 99 graphics operations will be executed at the regular speed of the emulator and 100th graphics operation will add to the execution time 100× times the wait factor for graphics operations.

In one embodiment of the invention, the sampling time is reduced to slices small enough to approximate the behavior of the target device behavior by successive approximation. For example, instead of 1 one-second sampling time, the sample time may be reduced to 0.1 seconds, or 0.01 seconds or even less.

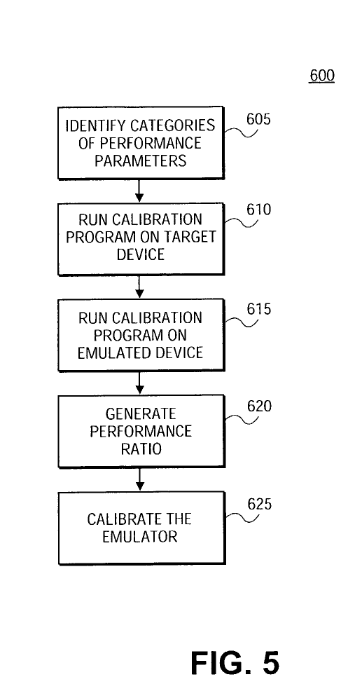

The flowchart in FIG. 5 is a flowchart illustrating an exemplary method 600 of calibrating emulation device performance. First, performance parameter categories are identified for the target device (step 605). In one embodiment, a user may identify or select the parameter categories from a pre-programmed list of possible performance categories. Categories may include processor, graphics, network, and/or storage. The following examples can also be implemented using additional categories, to extend to any granularity or division of performance, including, but not limited to, incoming and outgoing network performance; serial connection performance; audio input and output; video input, output, and display; reading and writing to storage; etc.

Next, the calibration program is run on the target device and the emulated device (steps 610 and 615). The order in which the calibration program is run on the target and emulated devices is not important. The calibration program generates measurements in all the categories identified or selected. In one embodiment, the calibration program is pre-run on a standard set of categories, generating benchmark measurements. Each measurement may be any type of rate that can be benchmarked. This may be called a rate measurement. For example, for processor performance, the measure may be byte codes executed per second; for graphics performance, the measure may be pixels drawn per second; for network performance, the measure may be bytes transferred per second; and for storage performance, the measure may be bytes transferred per second.

Thereafter, a performance ratio for each performance parameter may be generated (step 620). This performance ratio is a value that links the target device to the specific emulator and platform. The ratio value can be used to generate adjustment values for the calibration of the emulator. These values may also be used to indicate the difference in performance between two different types of devices. If two different target devices are measured, the performance ratio gives an approximation in the difference in performance between the devices. The closer a performance ratio is to one, the more similar the performance of the device in the particular category. In another embodiment, this value can be used to identify particularly bad emulators or slow workstations.

In another embodiment, a set of benchmark performance measurements may be created. These can be used to give a benchmark performance ratio for a target device. The benchmark performance ratio may be used to analyse performance across device types.

Finally, the emulator is calibrated (step 625). The emulator is calibrated by introducing adjustment values into the processing of an application program. These adjustment values function to slow down the emulator to better reflect target device performance. In one embodiment, an emulator may be designed to accept a set of performance measurements from an outside source. The emulator may be designed to generate performance ratios and introduce the required delays into the functioning of the emulator. This receipt of performance measures may take place through a synchronization of the devices to transfer values or permit manual data entry of the values.

The adjustment value can be introduced into the emulator at several points. In one embodiment, it is introduced at the instruction level, with the emulator analyzing every machine instruction, determining type, and adjusting accordingly. In another embodiment, at the code line level an adjustment value is introduced. Every line of code is reviewed and processed during compile time. The instructing instructions are marked as a specific type and an adjustment value is inserted to implement the calibration. In another embodiment, the adjustment value is introduced at the function level. This is similar to the code line level, but the code is marked by functions or methods instead of lines. In another embodiment, the time adjustment may be introduced at the design level by having the developer to mark the code to tell the compiler and/or emulator what category (graphics, processor, etc.) the code/function belongs to. However the adjustment values are inserted, they serve to calibrate the emulator to reflect the target device performance.

Although embodiments of the present invention are described as being associated with programs stored in memory and other storage mediums, one skilled in the art will appreciate that these aspects can also be stored on, or read from, other types of computer-readable media, such as secondary storage devices, like hard disks, floppy disks, or CD-ROM; a carrier wave from the Internet; or other forms of RAM or ROM. Accordingly, the invention is not limited to the above-described embodiments, but instead is defined by the appended claims in light of their full scope of equivalents.

Further, methods consistent with embodiments of the invention may conveniently be implemented using program modules. Such program modules, when executed, may perform the steps and features disclosed herein, including those disclosed with reference to the exemplary flow chart of FIG. 5. No particular programming language has been indicated for carrying out the various procedures described above because it is considered that the operations, stages, and procedures described above and illustrated in the accompanying drawings are sufficiently disclosed to permit one of ordinary skill in the art to practice the invention. Moreover, there are many computers and operating systems that may be used in practicing embodiments of the instant invention and, therefore, no detailed computer program could be provided which that would be applicable to these many different systems. Each user of a particular computer will be aware of the language and tools that which are most useful for that user's needs and purposes.

The above-noted features and aspects of the present invention may be implemented in various environments. Such environments and related applications may be specially constructed for performing the various processes and operations of the invention, or they may include a general-purpose computer or computing platform selectively activated or reconfigured by program code to provide the functionality. The processes disclosed herein are not inherently related to any particular computer or other apparatus, and aspects of these processes may be implemented by any suitable combination of hardware, software, and/or firmware. For example, various general-purpose machines may be used with programs written in accordance with teachings of the invention, or it may be more convenient to construct a specialized apparatus or system to perform the required methods and techniques.

Embodiments of the present invention also relate to computer-readable media that include program instructions or program code for performing various computer-implemented operations based on the methods and processes of embodiments of the invention. The program instructions may be those specially designed and constructed for the purposes of the invention, or they may be of the kind well known and available to those having skill in the computer software arts. Examples of program instructions include, for example, machine code, such as produced by a compiler, and files containing a high-level code that can be executed by the computer using an interpreter.

Other embodiments of the invention will be apparent to those skilled in the art from consideration of the specification and practice of the embodiments of the invention disclosed herein. It is intended that the specification and examples be considered as exemplary only, with a true scope and spirit of the invention being indicated by the following claims.

What is claimed is:

1. A system for calibrating an emulated device, comprising:
means for generating a measurement of at least one parameter associated with the performance of the target device and the emulated device;
means for determining an adjustment value for the emulated device associated with each parameter; and
means for integrating each adjustment value into the emulated device to reflect the performance of the target device.

2. The system of claim 1 wherein the means for generating a measurement of executed parameter operations and average parameter operation time.

3. The system of claim 1 wherein the means for determining an adjustment value obtains is a ratio of the target device measurement to the emulated device measurement.

4. The system of claim 3 wherein the ratio is the target device measurement divided by the emulated device measurement.

5. The system of claim 3 wherein the means for integrating the adjustment value alters the performance of the emulated device based on the ratio.

6. The system of claim 5 wherein altering the performance adds the adjustment value to the execution of a parameter operation.

7. The system of claim 1 further comprising:
means for transferring the target device measurement to the emulated device.

8. A calibration system, comprising:
a target device;
an emulated device in communication with the target device;
means for generating a measurement for at least one performance parameter on the target device and the emulated device generating a target device measurement and an emulated device measurement;
means for obtaining an adjustment value of the target device measurement to the emulated device measurement; and
means for altering a performance parameter operation of the emulated device to reflect the performance of the target device.

9. A method for calibrating an emulated device to reflect the performance of a target device, comprising
identifying at least one performance parameter for the target device;
determining a performance ratio for the parameter;
integrating the performance ratio into the emulated device; and
executing an application program on the emulated device, the performance ratio permitting the performance of the emulated device to reflect the performance of the target device.

10. The method of claim 9 wherein the performance parameter is at least one of processing, graphics, incoming and outgoing network performance, serial connection performance, audio input and output, video input, output and display, and reading and writing to storage.

11. The method of claim 9 wherein determining the performance ratio further comprises:
generating a target device measurement and an emulated device measurement by running parameter operations on both the target device and the emulated device, wherein the average time of an operation is computed;
comparing the target device measurement and the emulated device measurement; and
determining the performance ratio based on the comparison.

12. The method of claim 9 wherein integrating the performance ratio alters the performance of the emulated device based on the ratio.

13. The method of claim 9 wherein integrating the performance ratio further comprises creating an adjustment value based on the performance ratio and introducing the adjustment value into a parameter operation.

14. The method of claim 13 wherein introducing the adjustment value includes at least one of evaluating machine instructions for the parameter operation, evaluating code for the parameter operation, and evaluating functions for the parameter operation.

15. The method of claim 9 wherein executing an application program on the emulated device creates a visual display of the application program running on the emulated device.

16. The method of claim 9 wherein executing an application program on the emulated device returns a value for the execution of the application program running on the emulated device.

17. The method of claim 9 further comprising:
transferring the target device measurement to the emulated device.

18. A computer-readable medium that stores instructions, which when executed perform steps in a method for calibrating emulator performance, the steps comprising:
identifying at least one performance parameter for a target device;
determining a performance ratio for the performance parameter;
integrating the performance ratio into the emulator; and
executing an application program on the emulator, whereby the performance ratio permits the performance of the emulator to reflect the performance of the target device.

19. The computer-readable medium of claim 18 wherein the step of determining the performance ratio further comprises:
generating a target device measurement and an emulated device measurement by running parameter operations on both the target device and the emulated device, wherein the average time of an operation is computed;
comparing the target device measurement and the emulated device measurement; and
determining the performance ratio based on the comparison.

20. The computer-readable medium of claim 18 wherein the step of integrating the performance ratio alters the performance of the emulated device based on the ratio.

21. The computer-readable medium of claim 18 wherein the performance parameter is one of a processor-performance measurement, a graphics-performance measurement, a network-performance measurement and a storage-performance measurement.
